(19) United States
(12) Patent Application Publication
(10) Pub. No.: US 2022/0032095 A1
(43) Pub. Date: Feb. 3, 2022

(54) DEVICE FOR SEPARATING FINE PARTICLES OF MOISTURE FROM AN AIR FLOW

(71) Applicant: MPOINTAERO Inc., Fairfax, VA (US)

(72) Inventors: Maksim Vladimirovich BELOUSOV, Moscow (RU); Vladimir Egorovich BELOUSOV, Saint Petersburg (RU)

(21) Appl. No.: 17/283,468

(22) PCT Filed: Oct. 7, 2019
(86) PCT No.: PCT/RU2019/050177

§ 371 Date: Oct. 15, 2021

(30) Foreign Application Priority Data
Oct. 8, 2018 (RU) 2018135266

(51) Int. Cl. A62B 23/02; A41D 13/11

(52) U.S. Cl. CPC A62B 23/02; A41D 13/11

(57) ABSTRACT

The present invention relates to the field of medicine and is devised to protect a person from airborne infections. Proposed is a device hr separating finely dispersed particles of liquid (saliva) from an air stream, the device comprising elements in the form of annular partitions which are mounted inside a housing (housing, mask, tube, etc.), along the path of the air stream, said annular barriers being arranged in order at predetermined intervals from one another and together completely blocking passage of the air stream. The technical result which can be achieved using the invention is the provision of maximum protection of a person from airborne infections, with minimal respiratory resistance.

### TECHNICAL FIELD

The invention relates to the field of medicine and is devised to protect a person from airborne infection. The invention is a device for retaining and separating finely dispersed particles of a liquid from an air stream, with a minimum of respiratory resistance.

### PRIOR ART

### Summary of the Invention

The prior art discloses devices for retaining moisture and dust, the principle of operation of which is based on use in the form of partitions (barriers) which partially protrude into a cavity of a housing of the device (a mask) and retain finely dispersed particles of water and dust in the air stream passing therethrough. Furthermore, with the goal of reducing respiratory resistance, the main part of the air stream is directed so as to bypass the partitions.

Thus, U.S. Pat. No. 1,946,744 (published 13 Feb. 1934) describes a filter having a housing in which a series of components in the form of partitions which partially protrude into an opening are disposed along the air stream path, each being a frame with a metal wire winding.

A similar partition structure is devised to capture solid dust-like particles in industrial devices and is not devised, for example, to separate moisture particles from an air stream. Additionally, partitions (barriers) acting as filtering components block the air stream only partially, and consequently part of the contaminated air stream does not interact with the filter components. A significant drawback of the aforementioned device is the impossibility of use thereof for protecting against airborne infection.

Application WO2007012060 (published 25 Jan. 2007) proposes a device for additional protection of a patient's trachea during intubation, comprising at housing with open upper and lower ends, containing in an internal channel a dividing wall with an oblique partition, designed to remove sputum.

The structure of the device is devised to remove a viscous, gel-like liquid (sputum) while performing endotracheal anesthesia and cannot be used, for example, to separate finely dispersed particles of saliva which is contained in the inhaled air and which has fundamentally different physical properties.

Structurally, the device for protecting human respiratory organs disclosed in application WO2015131876 (published 11 Sep. 2015) is closest to the claimed invention. The proposed mask is devised to purify inhaled air of smoke and metallic dust in industrial manufacturing and is provided in the form of a hollow box. The box is completely filled with a filtering material (cotton fiber), inside of which components are disposed in the form of partitions which partially block the air stream, the main purpose being additional fixation of the filter.

Significant drawbacks of the known device include extremely high respiratory resistance which significantly reduces a person's capacity to work. In addition, when device is used for something other than the main purpose thereof, for example to protect against airborne infection, after a few minutes the cotton filter quickly becomes clogged with finely dispersed saliva, preventing the passage of air, and the built-in partitions only further increase respiratory resistance.

A common drawback of the known devices is the following.

None of the known devices are geared outright towards retaining finely dispersed particles of saliva. Nevertheless, airborne infections are transmitted from person to person only via finely dispersed particles of saliva which has fundamentally different physical properties from water and other standard fluids, being a “non-Newtonian liquid” and having high adhesion. For this reason, known methods for removing moisture (water) from the air stream in relation to the dispersion of saliva are in practice ineffective, including due to high respiratory resistance and rapid failure connected with blockage of the filtering components. In addition, the attendant change in the moisture content in the inhaled air during the provision of medical care, which is intrinsic to known devices, is undesirable and requires additional correction.

### Technical Problem

The main object of the present invention is to develop a device that purifies inhaled air of airborne infections.

The problems to be solved be the present invention are separation of finely dispersed liquid particles (saliva) from an air stream passing through inside a housing (for example a face mask) without using filtering materials, thereby ensuring minimal respiratory resistance for the user and increasing the useful life of the device.

### Solution of the Problem

The technical result achieved by use of the invention is selective separation of finely dispersed particles of liquid (saliva) from the air stream, while maintaining the basic physical properties thereof, including respiratory resistance and humidity.

The given technical result is achieved by the invention for separating finely dispersed particles of liquid (saliva) from the air stream, containing components inside a housing in the form of annular partitions which are arranged in order at fixed intervals from each other generally forming a cone which completely blocks the air stream.

The components are arranged at intervals from each other in order to allow free passage therebetween of an air stream. The principal requirement for the arrangement of the components is to ensure complete coverage of the channel cavity through which the air stream passes, i.e., there should be no through gaps in the path of the air stream, as in, for example, the known analogs. Due to the presence of free space between the components and the configuration thereof, there is no noticeable resistance in the air stream during breathing.

The principle of protection against airborne infection by a device for separating a fine dispersion of liquid (saliva) from an air stream is based on the physical law of Coanda (the “Henri Coanda effect”) which is widely used in practice (for example in aviation): “the effect of separation from and adhesion to an air stream of a liquid as it flows around a solid body.”

The entire volume of the air stream entering during entry into the cavity of the housing (for example a mask), in which the claimed device is disposed, passes through components arranged in order, passing from a laminar state to a turbulent one. The inertia of the particles of saliva to high-density liquid) in the turbulent air stream differs significantly from the inertia of the particles of the stream (gas) itself, due to which their separation occurs. Particles of saliva which collide with the solid components of the device lose their inertia and, having high adhesion (in contrast to water), adhere to surfaces thereof. Thus, as the air stream passes, it is freed from the dispersion of saliva contained therein, and, in turn, from the airborne infection contained therein. The free spaces between the components (in contrast to the pores in the filtering fabrics) are not clogged with moisture, i.e., respiratory resistance does not arise for the user as the device is used.

With the goal of protecting against airborne infection contained in the inhaled air and due to the insignificant resistance during breathing, the claimed device can be installed along the path of air streams in frame-type medical masks, along air ducts in anesthesia equipment, ALV (artificial lung ventilation), in infectious wards for additional environmental protection, and in gas masks, etc.

In one of the preferred embodiments of the invention, the components of the device are annular and generally form at least one three-dimensional cone shape in which the outer circumference of each successive component is greater than the inner circumference of the previous component, making it possible to completely block the passing air stream. One of the components of the inventive device is provided with a shape and dimensions so as to completely overlap the central opening of one of the annular components. In particular, the smallest component at the top of the three-dimensional shape does not have an inner hole, i.e., it is provided in the form of a disc or cone.

The largest component of the shape hermetically seals with the entire outer circumference thereof the inner surface of the housing, imitating the shape thereof.

In another preferred embodiment, the device is provided in the form of two truncated cones with a common top or common base. This embodiment of the device makes it possible to achieve the same effect on air streams both during inhalation and exhalation.

The number of components of the claimed device and the interval therebetween depend on the requisite characteristics of the device and are determined empirically.

The components of the device can be arranged perpendicularly or at an angle relative to the direction of the air stream, but in all cases partially overlapping of each other.

Each component may have a surface of different shapes, for example flat or curved, or more complex so as to provide the necessary aerodynamics, for example.

The components of the claimed device, depending on the structure and purpose, may be made of medical plastic, a fabric (for example cotton), paper or cardboard, or silicone or a metal (for example thin foil).

The surface of the components may additionally be coated with various materials, bactericidal agents, adsorbents, and so forth.

Since the components have two opposing sides, the sides can be covered with materials of different properties along the inhalation and exhalation paths. Thus, the surface of the component on the side of the air stream intake may be covered with a steely substance (for example BF-2 glue) for additional dust retention, and on the outlet (exhalation) side it can be covered with an adsorbent (for example a microfiber layer) devised to farther capture the dispersion of saliva contained in the exhaled air.

The claimed invention may be provided by casting or be assembled from separate components.

In one preferred embodiment of the device, the components are interconnected to form a single structure, for example by means of a fastening component, in particular at least one or more rods. The optimal number of such rods is three.

In another preferred embodiment of the device, at least one of the components is connected to the frame, specifically being attached directly to the wall of the frame by means of glue or a fastening material.

If necessary, a combination of fasteners is possible, i.e., at least one component of the shape can be attached directly to the inner surface of the housing of the device, for example using glue, with at least two components being connected to each other by means of a rod.

### BRIEF DESCRIPTION OF THE DRAWINAGS

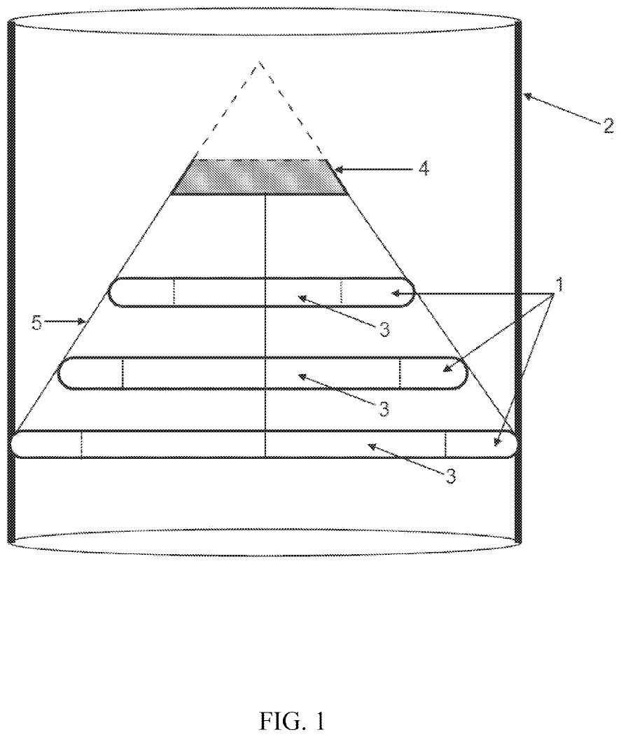

FIG. 1 is a general view of the device according to one of the embodiments of the present invention, provided in the form of a truncated cone. Side view. All components are interconnected.

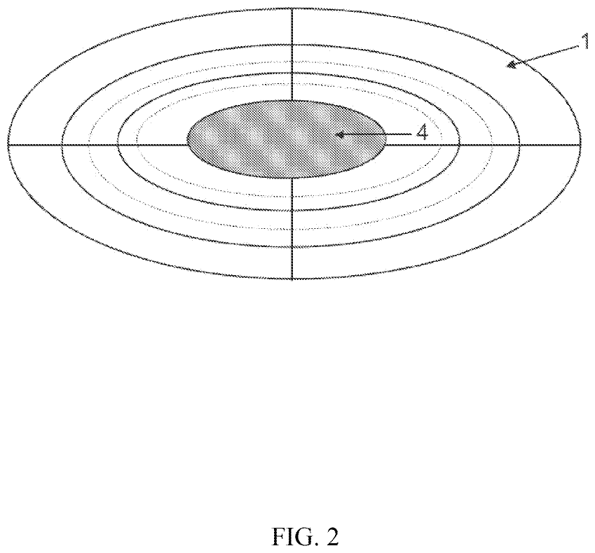

FIG. 2 shows a top view of the device shown in FIG. 1.

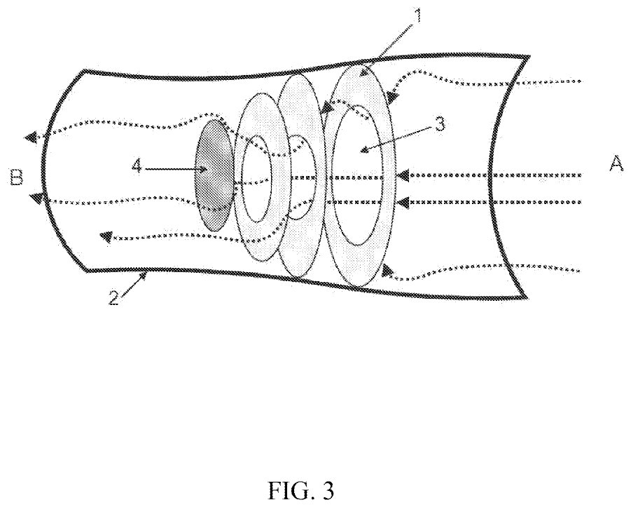

FIG. 3 shows a schematic diagram of operation of the device shown in FIG. 1 and disposed in the housing.

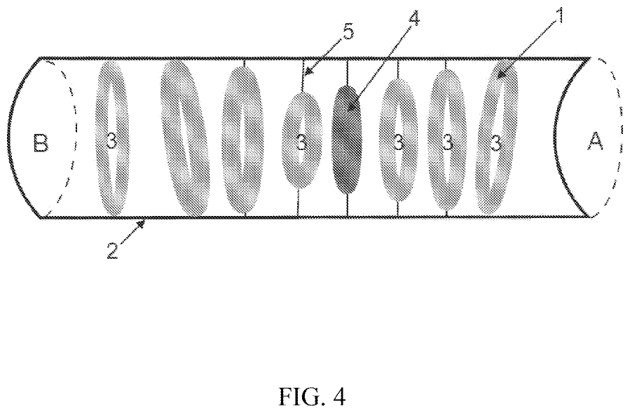

FIG. 4 shows an embodiment of the device in the form of two truncated cone shapes with a common top and disposed in the housing. Each component is attached to the housing.

### DESCRIPTION OF THE EMBODIMENTS

FIG. 1 shows an embodiment of the claimed device for separating finely dispersed particles of liquid (saliva) from an air stream.

As can be seen in FIG. 1, the device is provided in the form of a three-dimensional shape (a cone in the present embodiment), comprising separate components (1) and (4) which are arranged in order and at intervals from each other and disposed in a housing (2).

In the present embodiment of the invention, the components (1) are provided in an annular shape, with openings (3) in the center.

It is shown that the annular components are arranged such that the outer diameter of each subsequent component is greater than the diameter of the opening of the previous ring.

The top of the shape which is provided in the form of a cone is a disk (4) or other shape having appropriate dimensions and a protrusion so as to ensure complete overlap of the central opening of the previous annular component of the device.

In the present embodiment, all components of the shape are interconnected by means of rods (5). The shape is maintained in the housing cavity due to the tight and hermetic fit of the largest component to the housing. If necessary, any component may also have its own independent attachment to the housing.

FIG. 2 is a top view of the device shown in FIG. 1, indicating that all the components (rings) overlap each other so that there are no through-gaps in the projection from above.

The inventive device is mounted along the path of the passage of air streams inside the housing, for example on a pipe or frame, through which atmospheric air is supplied to the human respiratory organs, for example in an artificial respiration apparatus, a special mask, gas mask, and so forth.

During inhalation, air enters the housing from side A (FIG. 3), and during exhalation from side B.

FIG. 3 schematically shows the principle of operation of the claimed device. Dash-and-dot arrows indicate the direction of movement of the air stream passing through the components (1), curving around each component and partially passing through the inner opening thereof (3).

Passing through the components of the device, the laminar air stream creates turbulence around each component (acting as a barrier), as a result of which heavier finely dispersed saliva drops sharply change speed and direction. Due to the Coanda effect and the adhesion, when colliding with the components of the device, small particles of saliva are retained on surfaces thereof. Under standard conditions (during calm breathing of a person), i.e., at a relatively low speed of the air stream and an appropriate number of components, almost all the finely dispersed saliva can be removed.

Thus, the inhaled air is purified of airborne infections, for example the influenza virus, the tuberculosis bacillus, and so forth. With this air stream, which does not contain finely dispersed saliva, practically does not interact with the device, i.e., it does not contaminate it, thus prolonging its service life.

The degree of purification of the air stream depends on the number, size, and shape of the components contained in the device. The larger the total area of the components that make up the device, the more efficient the purification process.

In view of the fact that the components of the device (fer example the annular ones) only partially change the direction of the air stream, there is practically no respiratory resistance.

As noted above, the intervals between the rings depend on specific conditions and the given problems and are determined experimentally or through calculation, i.e., in the given way. For example, the minimum interval between the components is determined by an increase in the user's permissible respiratory resistance or by the technical parameters of the air purification devices, perhaps being a fraction of a millimeter. The maximum interval depends on the dimensions of the frame. For example, if the frame is a pipe, then the interval between the first and last components could reach a meter or more. The intervals between different pairs of components and their relative positions can vary significantly, which ought be due to the configuration of the frame and aerodynamic conditions.

The minimum number of components may be two. For example, a ring and a disc covering the center hole of the ring.

The greater the interval between the components, the lower the respiratory resistance, but also the lower the purifying effect.

The smaller the interval between the components, i.e., the denser the components are and the greater number thereof, the more effective the protection against airborne infection, but also the stronger the respiratory resistance.

The shape and dimensions of the components and, accordingly, the three-dimensional shape formed thereby depend on the shape (cross-section) of the housing cavity for which they are devised.

In order to obtain the claimed result, the requisite conditions for the device are:

the absence of any gaps for free passage (i.e., without touching the components) of the air stream in the housing, and

arrangement of the components in order at intervals from each other, forming therebetween free spaces (i.e., not filled, for example, with a filtering material) which are sufficient for the unhindered passage of an air stream.

To provide an effect on air streams in both directions (on inhalation and exhalation) in order to enhance the degree of air purification and broaden functionality, the device may comprise two truncated cones, for example by interposing discs as shown in FIG. 4.

Depending on the manufacturing technology, the discs (4) may be glued together from different truncated cones, or a disc (4) may be common to two truncated cones.

This structure provides greater rigidity and durability by affixing a larger number of rings.

1. A device for separating finely dispersed particles of moisture from an air stream, comprising components attached to an inner surface of a housing along the path of an air stream, wherein the components are annular in shape and are disposed along the path of streams of inhaled and exhaled air containing saliva particles.

2. The device as claimed in claim 1, wherein the components collectively form at least one three-dimensional shape in which the outer diameter of each subsequent component is greater than the diameter of the previous component, and the smallest component located at the top of the shape provides complete overlap of the central opening of the preceding annular component.

3. The device as claimed in claim 1, wherein the components are interconnected, forming a single structure.

4. The device as claimed in claim 2, wherein the components are interconnected, forming a single structure.
